(19) United States
(12) Patent Application Publication
(10) Pub. No.: US 2002/0116164 A1
(43) Pub. Date: Aug. 22, 2002

(54) Matched instruction set processor systems and efficient design and implementation methods thereof using java programming language

(76) Inventor: Hussein S. El-Ghoroury, Carlsbad, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/051,217

(22) Filed: Jan. 18, 2002

Related U.S. Application Data
(60) Provisional application No. 60/262,803, filed on Jan. 19, 2001.
(60) Provisional application No. 60/268,835, filed on Feb. 13, 2001.
(60) Provisional application No. 60/268,836, filed on Feb. 13, 2001.

(51) Int. Cl. G06F 17/50

(52) U.S. Cl. 703/14

(57) ABSTRACT

This invention relates to matched instruction set processor systems and methods to efficiently design and implement the matched instruction set processor systems. A method to efficiently design and implement a matched instruction set processor system includes analyzing and mapping design specifications of the matched instruction set processor into application components, wherein each application component represents a reusable function commonly used in digital communication systems. The method further includes decomposing the matched instruction set processor system into interconnected design vectors, wherein the design vectors are presented in the Java programming language. The method also includes analyzing and mapping the interconnected design vectors into specific hardware and software elements.

### RELATED APPLICATIONS

This application claims the benefit of U.S. Provisional Patent Application No. 60/262,803 filed on Jan. 19, 2001 (Attorney Docket No. 005444.P001Z), U.S. Provisional Patent Application No. 60/268,835 filed on Feb. 13, 2001 (Attorney Docket No. 005444.P005Z), and U.S. Provisional Patent Application No. 60/268,836 filed on Feb. 13, 2001 (Attorney Docket No. 005444.P006Z).

### BACKGROUND

(1) Field

This invention relates to matched instruction set processor systems and methods to efficiently design and implement the matched instruction set processor systems.

(2) General Background

Traditional Application Specific Integrated Circuit (ASIC) design methods and the “Fabless Integrated Circuit (IC)” business model have worked well for the personal computer (PC) industry for many reasons. The primary reason is that PC design requirements typically do not radically change from one product to another. In comparison, the wide spread proliferation and constant evolution of the communications standards cause product design requirements of digital communication products to significantly change from one product to the next product. As a result, the overhead resulting from applying ASIC design methods and the “Fabless IC” business model to Digital Communications products are far more excessive.

Generally, the value that a typical digital communication semiconductor company following the “Fabless IC” business model offers is concentrated in the design content of the IC. Typically, the semiconductor technology offered by many fabless semiconductor companies is merely a redesign and re-packaging of components that the companies have previously designed. These fabless companies generally expend disproportional monetary and human resources to re-package various communication components to produce products. Therefore, chip design cycles normally assume a substantial portion of the total cost of final products.

There are several other significant shortcomings of the “Fabless IC” business model and ASIC design methods when applied to the development of digital communication products. These shortcomings arise basically from the fact that the implementation of digital communication products typically includes embedded software that is not well integrated into the design process. Some exemplary shortcomings may include:

Lack of a unified hardware (HW) and software (SW) design approach, leading to difficulties in verifying the integrated design, and hence incompatibilities across the hardware and software boundary.

Tendency to define a priori a partitioning of hardware and software, leading to rigid and sub-optimal designs.

Lack of well-defined design flow, making specification revision difficult and hence impacting time-to-market.

Lack of built-in techniques within the design process to promote reusability and portability, preventing timely reaction to market trends and leading to the inability to leverage attained market position.

As a result, it is desirable to have a new approach to communication processor design and design methodology that could overcome the aforementioned shortcomings and that is more compatible with the market evolution cycles in the digital communication semiconductor industry.

### BRIEF DESCRIPTION OF THE DRAWINGS

FIG. 1A illustrates two exemplary types of Vectors in accordance with one embodiment of the present invention.

FIG. 1B shows an exemplary Terminal Structural model expressed in terms of a set of interconnected Functional Vectors in accordance with one embodiment of the present invention

FIG. 2A is a diagram showing a plurality of exemplary tiers or stages in the Unified Design Methodology (UDM) in accordance with one embodiment of the present invention.

FIG. 2B shows an exemplary template for Functional Elements or Application Components in accordance with one embodiment of the present invention.

FIG. 2C illustrates the overall approach for the development of the behavioral model in accordance with one embodiment of the present invention.

FIG. 3A illustrates the overall structure of an exemplary UDM Design Vector in accordance with one embodiment of the present invention.

FIG. 3B shows an exemplary set of Vector Attributes in accordance with one embodiment of the present invention.

FIG. 3C shows exemplary variables definitions in accordance with one embodiment of the present invention.

FIG. 3D shows exemplary Methods of an exemplary UDM Design Vector in accordance with one embodiment of the present invention.

FIG. 4 generally illustrates various exemplary domains of reconfigurable hardware platforms in accordance with one embodiment of the present invention.

### DETAILED DESCRIPTION OF THE INVENTION

This invention relates to matched instruction set processor systems and methods to efficiently design and implement the matched instruction set processor systems.

Virtual Integrated Circuits (IC) are generally IC products whereby both of the software as well as the hardware aspects of the product are unified into a seamless architecture. Soft Products are generally Virtual Integrated Circuits designed to address a specific application but not targeting a specific hardware technology, platform or semiconductors technology and can be realized into an Application Specific Standard Product (ASSP) or run on a re-configurable hardware Platform.

The Virtual IC design method and business model can overcome many of the shortcomings of the “Fabless IC” model. In the Virtual IC model both of the software as well as the hardware aspects of the product design are unified into a seamless and unified design method. Furthermore, the hardware and software design aspects remain unified until the latter stages of the design are reached, thus allowing maximum flexibility to alter the functional allocation and partition between the hardware and the software aspects.

In the Virtual IC model, the design is not committed to a specific hardware architecture, technology or foundry. Rather, the overall product design is verified and validated against the product design requirements then ported to the desired hardware architecture, the preferred technology and target foundry. This front-end design process independence prevents the dilution of the product designers' value-added encountered in the Fabless IC model while retaining the flexibility to port the design to any desired hardware architecture, technology or foundry. Furthermore, the decoupling of the chip design from the product design frees hardware designers to evolve and eventually replace their designs without perturbing legacy product designs.

In the Virtual IC model, design modularity is an integral attribute of the design and is incorporated at the onset of the design process. The design modularity in the Virtual IC model is done in such a way that any single module can be committed to either hardware or software implementation and can be reused from one product realization to another. In effect the design modularity provisions in the Virtual IC model allows hardware/software partition flexibility as well as reusability.

In summary, the Virtual IC model attains maximum efficiency for Digital Communication products through Portability across hardware platforms and Reusability across digital communication standards.

Matched Instruction Set Processors are generally processors that can be adapted or reconfigured to support a variety of base instruction sets. These processors can be matched to individual tasks that a communication processor is expected to perform. As a result Matched Instruction Processors are good candidates for implementing communication processors targeted to changing communication applications and standards. As such, Matched Instruction Set Processors support reconfigurable computing architectures, thereby enabling adaptation of hardware resources to perform a specific computation. Reconfigurable computing architectures can provide an alternate paradigm to utilize the available logic resources on the chip. For several classes of applications (including digital communication applications), Matched Instruction Set Processors that support reconfigurable computing architectures could provide power optimization, cost reduction, and enhanced run-time performance.

Matched Instruction Set Processors are made up of specific hardware and software objects or elements. These processors can be described as multiple parallel-processing pipelines that contain interconnected Functional and Interconnection Vectors, with each of the Application Models corresponding to one or more Vectors.

In one embodiment, each parallel-processing pipeline can contain one or more Functional Vectors and/or Interconnect Vectors. A Vector can be generally defined as a portion of a processing pipeline that requires no further parallelism. A Functional Vector generally contains design information for one or more functional aspects of the processing pipeline. An Interconnect Vector generally contains design information for connectivity characteristics.

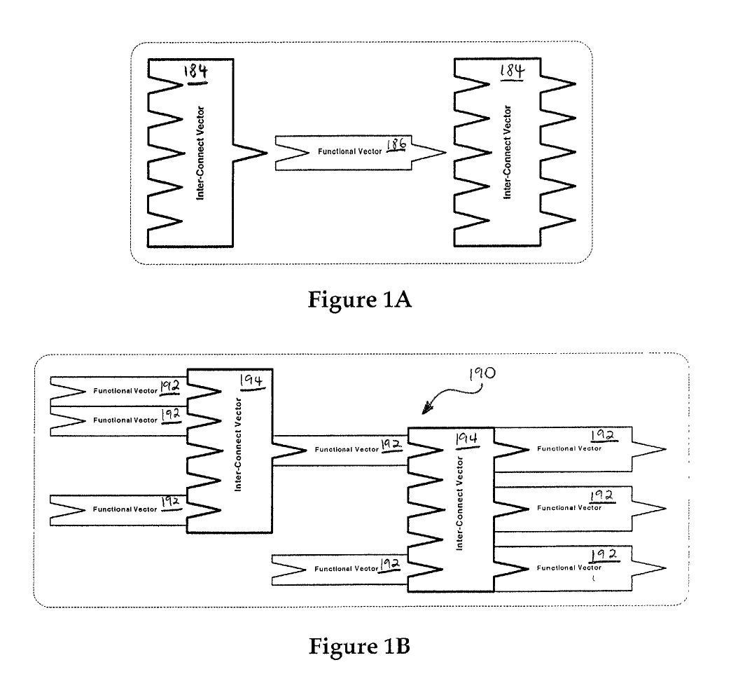

FIG. 1A illustrates two exemplary types of Vectors in accordance with one embodiment of the present invention. Vectors are the most basic building blocks with which the terminal architectural model can be constructed. As shown in FIG. 1A, two exemplary types of Vectors include Functional Vectors 186 and Interconnect Vectors 184. In one embodiment, each Functional Vector 186 can be dedicated to performing a single function of transforming the input variables into the output variables. It should be noted that Functional Vectors 186 could be restricted to receive their input variables from a single Interconnect Vector and deliver their output variables to a single Interconnect Vector.

In one embodiment, Interconnect Vectors 184 can be used to provide the interconnectivity between Functional Vectors 186. Each Interconnect Vector 184 can typically perform the functions required to contain and transport shared and global variables between Functional Vectors 186. If an Interconnect Vector 184 interconnects two Functional Vectors 186, variables exchanged between the two Functional Vectors 186 are shared variables. If an interconnect vector transports variables between more than two Functional Vectors 186, the transported variables are global variables.

FIG. 1B shows an exemplary Terminal Architectural model 190 that is expressed in terms of a set of interconnected Functional Vectors 192 in accordance with one embodiment of the present invention. Interconnect Vectors 194 are used to link or interconnect the Functional Vectors 192. As previously stated, Interconnect Vectors 194 and Functional Vectors 192 represent the lowest level of building blocks that will be used in building the terminal structural model. Each Vector is implemented by a Scaled Virtual Machine supporting the required computing capabilities. Examples of computing capabilities or features may include an instruction set, processing throughput requirement, memory requirement, etc. A Scaled Virtual Machine generally includes computing capabilities or features that represent a truncation or extension of pre-determined computing capabilities or features of a default virtual machine.

In one embodiment, the Java Virtual Machine (JVM) is used to implement the default virtual machine. In this embodiment, capabilities or features of the default virtual machine or the JVM can be extended or truncated to define an instance of the Scaled Virtual Machine that could meet the computing capabilities or features required by the Vector.

We will now describe the methodology to produce the aforementioned Matched Instruction Set Processor Architecture.

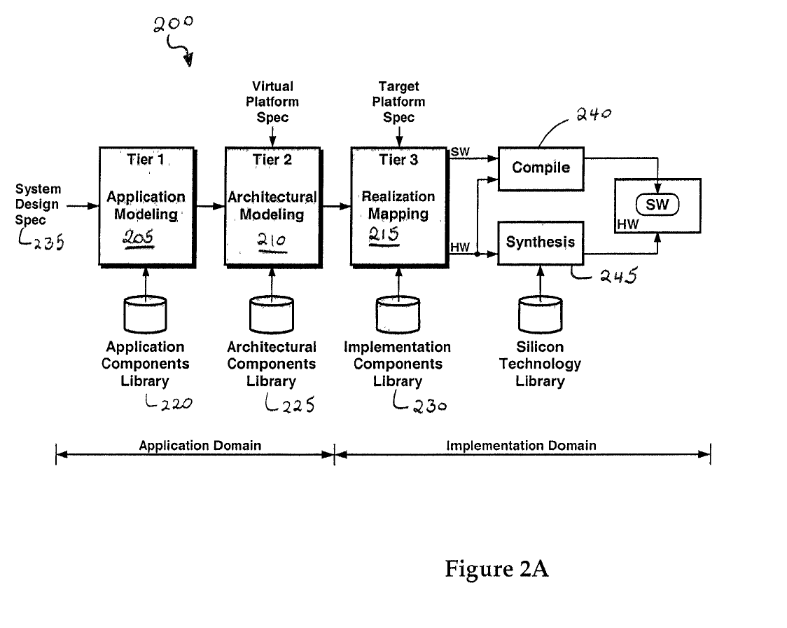

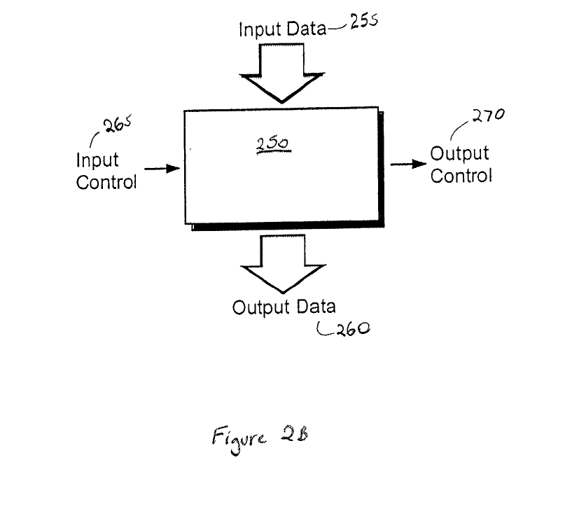

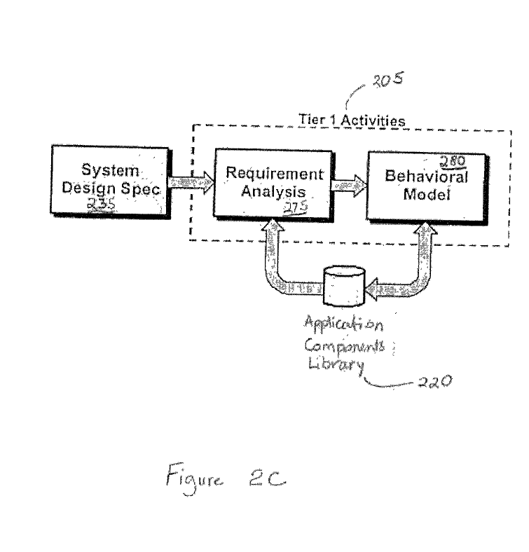

FIG. 2A is a diagram showing a plurality of exemplary tiers or stages 205, 210, 215 in the Unified Design Methodology (UDM) 200 in accordance with one embodiment of the present invention. The Unified Design Methodology 200 generally includes multiple tiers or stages 205, 210, 215. In each tier or stage 205, 210, 215, a different set of tasks is performed.

The Unified Design Methodology 200 generally provides an efficient technique to efficiently design and implement Matched Instruction Set Processors applicable to Virtual IC in general and digital communication Virtual IC in specific. Furthermore, the Unified Design Methodology 200 can enable the development of cost-effective digital communication Virtual IC products by incorporating all of the software as well as the hardware design aspects of the product and can be independently realized into a target hardware architecture, platform, or technology.

The Unified Design Methodology 200 is generally based on a multi-tier or multi-stage approach with each tier or stage 205, 210, 215 being supported by a corresponding design library 220, 225, 230. The Methodology 200 generally maps system design specifications 235 into hardware and software designs while allowing the incorporation of a preferred hardware specifications and constraints. Allocation or mapping of the system design to hardware and software is performed at the latter stages 240, 245 of the Methodology 200. Therefore, the overall system design can be verified before being committed, allocated, or mapped to actual hardware and software platforms. Thus the Methodology 200 allows the system design to be substantially independent of hardware platform and semiconductors technology. As a result, the resulting system design and its constituent elements can be realized using any preferred hardware platform and semiconductors technology.

In general, a Behavioral Analysis of the system design flow is performed in Tier 1 205 to ensure compliance with system design specifications 235. The process of ensuring compliance with system design specifications 235 is called Behavioral Verification.

In Tier 1 205, system design specifications 235 are analyzed and mapped into one or more Application Components. Appropriate pre-existing Application Components can be extracted from an Application Components Library 220, modified (if required) to be compatible with system design specifications 235, and incorporated into the system design flow. System design requirements, including processing and timing requirements, can also be allocated or mapped to the Application Components.

Each Application Component generally represents a reusable function commonly used in digital communication systems. A Functional Element generally represents a group of related functions, each of which performing specific tasks common to digital communication systems. Accordingly, each Functional Element can be composed of a group of interconnected Application Components.

FIG. 2B shows an exemplary template 250 for Functional Elements or Application Components in accordance with one embodiment of the present invention. Input Data 255 provides data to the Functional Element/Application Component 250. Functional Element/Application Component 250 generally processes the Input Data 255 and generates the Output Data 260. In processing the Input Data 255 and generating the Output Data 260, the Functional Element/Application Component 250 could maintain an internal state. Output Data 260 generally conveys the data output of the Functional Element/Application Component to another Functional Element or Application Component. Input Control 265 generally provides control input to the Functional Element/Application Component 250.

In one embodiment, the Input Control 265 may include timing information, processing preemption, configuration commands, or other control information. Output Control 270 generally provides control output from the Functional Element/Application Component. In one embodiment, the Output Control 270 may include operational status and other timing information that may be needed by another Functional Element/Application Component.

The result of Tier 1 205 is generally a Behavioral Model that can be used to verify compliance with system design specifications 235. As a result, engineering designers can think in high-level abstraction. It should be noted that no specific assumption is made in Tier 1 205 regarding the allocation of the system design specifications 235 and requirements into hardware and software. It should also be noted that Application Components residing in the Application Components Library 220 could be defined in a manner that will promote and enable reusability of the modules across various different digital communication standards.

FIG. 2C illustrates the overall approach for the development of the Behavioral Model. System Design Specifications 235 generally provide the requirements input to the Requirement Analysis phase 275 of Tier 1 205. Furthermore, the Application Components Library 220 contains existing Application Components that could be used during the generation of the Behavioral Model 280. In general, the Behavioral Model 280 can be generated using existing Application Components in the Application Components Library 220 and new Application Components identified during the Requirement Analysis phase 275. New Application Components can be saved in the Application Components Library 220 upon completion of the generation of the Behavioral Model 280 for later usage.

In some cases, each Application Component has some corresponding Architectural Components residing in the Architectural Components Library 225. If so, these corresponding Architectural Components are automatically incorporated in Tier 2 210 based on the Application Component generated in Tier 1 205.

If the Application Component generated in Tier 1 205 is a newly defined component, Architectural Components corresponding to the newly defined Application Component may need to be generated. To generate corresponding Architectural Components, a newly defined Application Component is first decomposed into one or more parallel processing pipelines in order to satisfy system processing and timing requirements.

Each parallel-processing pipeline can be further decomposed further into one or more Functional and Interconnect Design Vectors. A Design Vector can be generally defined as a portion of a processing pipeline that requires no further parallelism. A Functional Design Vector generally contains design information for one or more functional aspects of the processing pipeline. An Interconnect Design Vector generally contains design information for connectivity characteristics.

After each parallel-processing pipeline has been decomposed into one or more Design Vectors, the design of system can be represented by a set of interconnected Functional and Interconnection Design Vectors, with each Application Component generated in Tier 1 corresponding to one or more Design Vectors generated in Tier 2.

The processing requirements of each Design Vector can then be analyzed to determine computing capabilities or features that are needed to support the Design Vector. Examples of computing capabilities or features may include an instruction set, processing throughput requirement, memory requirement, etc. The required computing capabilities or features of each Design Vector can then be used to define a Scaled Virtual Machine. Thus, a Scaled Virtual Machine generally includes computing capabilities or features that represent a truncation or extension of pre-determined computing capabilities or features of a default virtual machine.

In one embodiment, the Java Virtual Machine (JVM) is used to implement the default virtual machine. In this embodiment, capabilities or features of the default virtual machine or the JVM can be extended or truncated to define an instance of the Scaled Virtual Machine that could meet the computing capabilities or features required by the Design Vector.

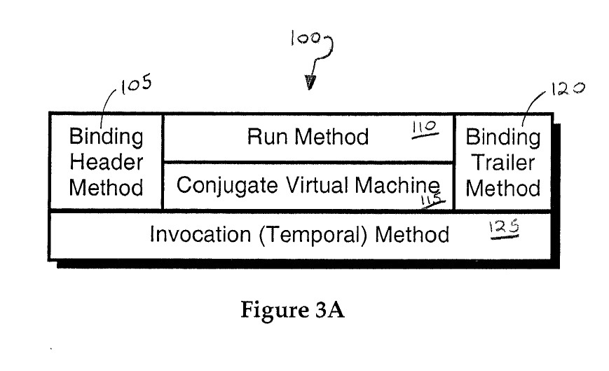

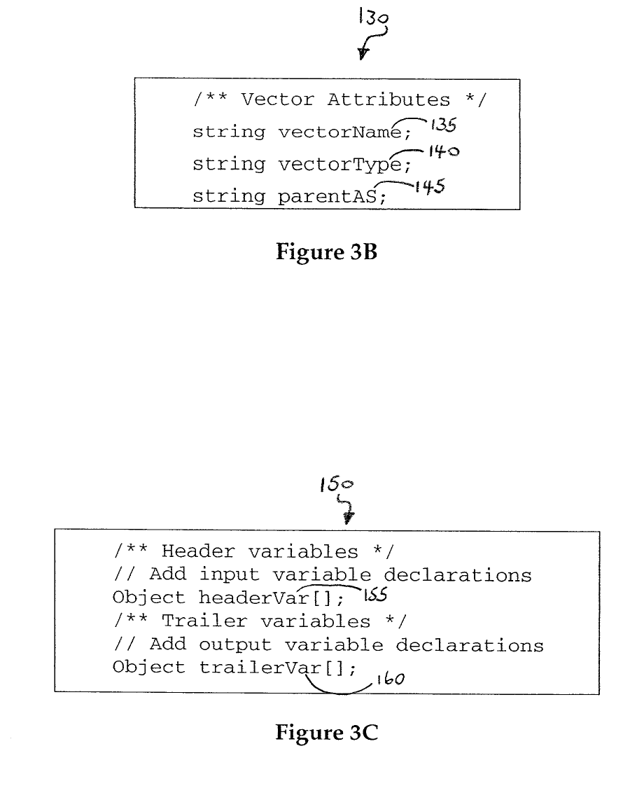

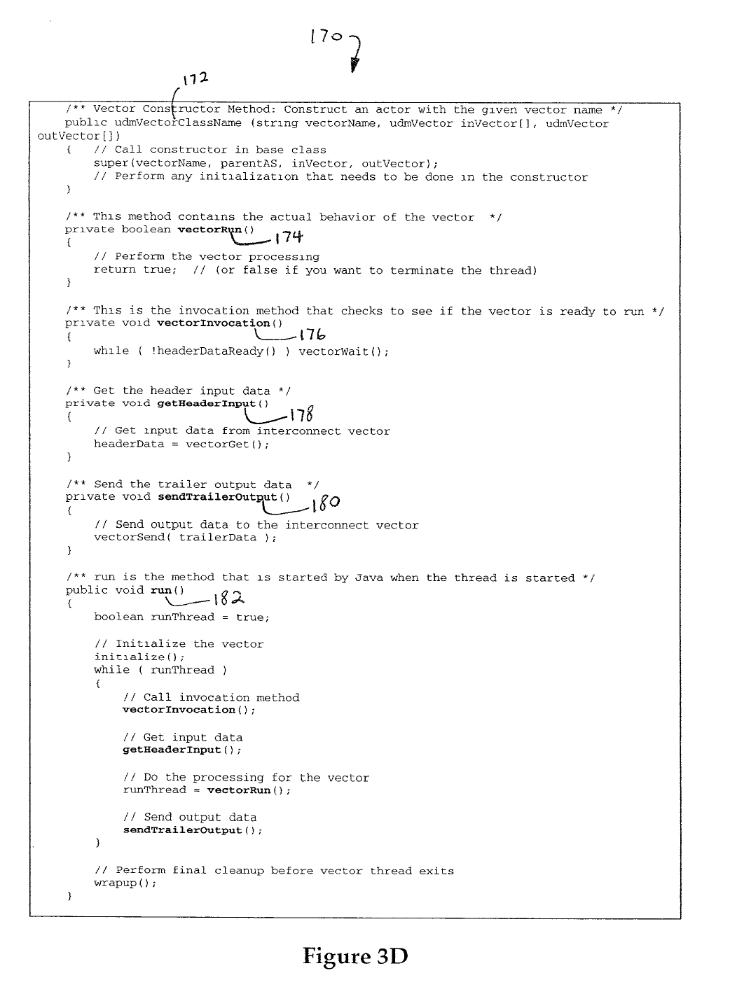

FIG. 3A illustrates the overall structure of an exemplary UDM Design Vector 200 in accordance with one embodiment of the present invention. The exemplary UDM Design Vector 200 can contain Run Method 210 and a definition of the “Matched” execution engine hardware, referred to as a Conjugate Virtual Machine (CVM) 215. Hence, the UDM Design Vector 200 can be represented as a software module executing on its own virtual (hardware) processor referred to as CVM. Header 205 and Trailer 220 contain the binding methods that connect the Design Vector 200 to other Design Vectors. Run Method 210 generally contains the behavior of the Design Vector 200.

In one embodiment, the Run Method 210 can include a Java software module that describes the processing to be performed by the UDM Design Vector 200. Temporal 225 typically contains the invocation method of the Design Vector. CVM 215 generally contains the description of the execution engine, which can be the JVM instruction subset that is needed to support the execution of the Run Method 210.

In one embodiment, the Header 205 generally contains the description of the input variables and the UDM Design Vectors that produce the input variables. In this embodiment, the Trailer 220 generally contains the description of the output variables and the UDM Design Vectors destined to receive the output variables.

In addition, the UDM Design Vectors 200 use the following types of Header and Trailer variables, including Local Variables, Shared Variables, and Global Variables. Local Variables are generally local within an UDM Design Vector. Shared Variables are typically shared between two Functional Design Vectors. Global Variables can be shared between several Functional Design Vectors.

Shared Variables and Global Variables can be accessed by multiple Design Vectors, and hence can be used to pass data between Design Vectors. Shared Variables and Global Variables are defined in the Header 205 and Trailer 220 of the Design Vector 200. Synchronization of access to Shared & Global Variables is performed data synchronization mechanisms provided by the selected design language. Examples of data synchronization mechanisms can include “wait( )” and “notify( )” methods, as defined by the Java programming language.

Temporal information 225 contains the invocation information and the maximum allowable response time within which the Design Vector 200 must complete its processing.

Conjugate Virtual Machine (CVM) field 215 generally includes design information describing required computing capabilities or features of the Scaled Virtual Machine that are minimally sufficient to execute the sequence of operations described in the Method field 210. Later in the Unified Design Methodology 100 (shown in FIG. 2A), the realization of the Scaled Virtual Machine as described in the CVM field 215 can be committed to either hardware or software depending upon the specified capabilities of a preferred platform 150 (shown in FIG. 2A). In one embodiment, the programming language can correspond to the default CVM that is being used. For example, the Java programming language would be used if the default virtual machine were a JVM. In this embodiment, the CVM describes the hardware that is the matched subset of the JVM instruction set generated by compiling the Design Vector Run Method.

Returning to FIG. 2A, the design of the system can be decomposed into a collection of interconnected Design Vectors in Tier 2 210 of the Unified Design Methodology 200 to fully capture hardware and software design aspects or features of the system. As stated above, the design information or specification of each interconnected Design Vector can be captured in a UDM Design Vector 200, as shown in FIG. 3A and described in the text accompanying the figure. Therefore, the collection of Design Vectors may be thought of as a detailed design document that captures hardware and software design aspects or features of the system.

As stated above, each of the interconnected Design Vector can be either a Functional Design Vector or an Interconnect Design Vector. In either case, the design of each Design Vector can be described using any design language. In one embodiment, the design language can be a programming language based on the object-oriented paradigm. An exemplary programming language based on the object-oriented paradigm is Java.

The description or specification of each UDM Design Vector should include hardware and software aspects or features. Thus, the design description or specification of each UDM Design Vector should be sufficiently complete to enable validation and verification against any design specifications that flows down to Tier 2 210 from Tier 1 205 of the Unified Design Methodology 200.

FIGS. 3B, 3C, and 3D together show an exemplary UDM Design Vector being implemented as a Java class. It should be noted that Javadoc comments are employed in the figures to further describe the UDM Design Vector. In one embodiment, the UDM Design Vector could include Class Name (i.e., name of the Java class that implements the exemplary UDM Design Vector), Design Vector Attributes, Variable Definitions, and Methods.

FIG. 3B shows an exemplary set of Design Vector Attributes 230, including Vector Name 235, Vector Type 240, and Parent Application Syntax 245. Vector Name 235 usually is the same as Class Name. Vector Type 240 can be used to indicate whether the vector is a Functional Vector or an Interconnect Vector. Parent Application Syntax name 245 is generally the Name of the Parent Vector.

FIG. 3C shows exemplary variables definitions 250 including Header 255 and Trailer 260 binding information. In one embodiment, the Header binding information 255 can include definitions of input variables and the name of the source vector generating these input variables. In this embodiment, the Trailer binding information 260 can include definitions of output variables and the name of the destination vector that will absorb these output variables.

FIG. 3D shows exemplary Methods 270 of an exemplary UDM Design Vector, including a Vector constructor method 272, a vectorRun( ) method 274, a vectorInvocation( ) method 276, a getHeaderInput( ) method 278, a sendTrailerOutput( ) method 280, a run( ) method 282, and other Java specific methods used to complete the vector—such as initialize( ), wrapup( ), vectorGet( ), vectorSend( ), vectorWait( ), headerDataReady( ), trailerDataReady( ).

The Vector constructor method 272 is generally called when the vector is first created. When called, the Vector constructor method 272 stores the Vector Attributes 230 (shown in FIG. 3B) and receives the Header and Trailer binding information 255, 260 (shown in FIG. 3C).

The vectorRun( ) method 274 can generally be invoked to perform the vector function. The vectorInvocation( ) method 276 generally contains the invocation and temporal information and waits until these requirements are satisfied. The getHeaderInput( ) method 278 can be used to obtain the Header binding information 255 (shown in FIG. 3C). The sendTrailerOutput( ) method 280 can be used to send the trailer variables to the bound vector that consumes the Trailer. The run( ) method 282 should exist in each Java thread and should be executed automatically when the Java thread is created.

Two exemplary types of UDM Design Vectors in accordance with one embodiment of the present invention were shown on FIG. 1A. The UDM Design Vectors are the most basic building blocks with which the terminal architectural model can be constructed. As shown in FIG. 1A, the two exemplary types of UDM vectors include Functional Vectors 286 and Interconnect Vectors 284. In one embodiment, each Functional Vector 286 can be dedicated to performing a single function of transforming the input variables into the output variables as described in the run( ) method 282 (shown in FIG. 3D). It should be noted that Functional Vectors 286 could be restricted to receive their input variables from a single Interconnect Vector and deliver their output variables to a single Interconnect Vector.

In one embodiment, Interconnect Vectors 284 can be used to provide the interconnectivity between Functional Vectors 286. Each Interconnect Vector 284 can typically perform the functions required to contain and transport shared and global variables between Functional Vectors 286. If an Interconnect Vector 284 interconnects two Functional Vectors 286, variables exchanged between the two Functional Vectors 286 are shared variables. If an interconnect vector transports variables between more than two Functional Vectors 286, the transported variables are global variables.

As previously stated, FIG. 1B shows an exemplary Terminal Structural model 290 that is expressed in terms of a set of interconnected Functional Vectors 292 in accordance with one embodiment of the present invention. Interconnect Vectors 294 are used to link or interconnect the Functional Vectors 292. As previously stated, Interconnect Vectors 294 and Functional Vectors 292 represent the lowest level of building blocks that will be used in building the terminal structural model.

Turning to FIG. 2A, in Tier 3 215 of the Unified Design Methodology 200, Design Vectors 100 (shown in FIG. 2A) are generally parsed and analyzed so that system design aspects or features can be mapped into specific hardware and software objects or elements.

In Tier 3 215, the hardware specifications and constraints of the preferred hardware platform can be superimposed on the output of Tier 2 210 to map designs of Vectors into detail designs of hardware and software objects or elements. Tier 3 215 is supported by an Implementation Components Library 230 containing detailed design of the Implementation Components that generally includes detailed designs of constituent elements of a Scaled Virtual Machine. Examples of constituent elements of the Scaled Virtual Machine may include instruction set primitives such as adder, multiplier, shifter, etc. The Implementation Components of Tier 3 115 can be expressed in the same design language used in Tier 1 205 and Tier 2 210.

Depending on the superimposed preferred hardware platform specifications and constraints, each Implementation Component can be mapped into specific hardware and software objects or elements in one of the following three ways. The Implementation Component can be substituted with an equivalent Component of the preferred hardware platform. In addition, the Implementation Component can be instantiated as a hardware element. Furthermore, the Implementation Component can be emulated using the Component of the preferred platform. Mapping of Implementation Components into one of three aforementioned ways is the general objective of Tier 3 215.

During the mapping process, data records generated in Tier 2 210 to describe interconnected Vectors are analyzed against the specifications and constraints of the preferred platform. Fields 105, 110, 115, 120, 125 in each Vector 100 (shown in FIG. 3A) are examined. Furthermore, design aspects or features of each Vector can be assigned to the preferred platform hardware, a supplementary hardware supporting the preferred platform, or software that will execute on the preferred hardware platform or the supplementary hardware supporting the preferred platform.

Generally if the Temporal or Timing Specification and the instruction set required to support each Vector are compatible with the capabilities of the preferred hardware platform, a collection of Vectors can be fused or grouped together and executed on one of the processing elements of the preferred hardware platform. In such a case, the Implementation Components of the fused or grouped Vectors can be substituted by the equivalent Implementation Components of the preferred hardware platform or emulated using the Implementation Components of the preferred platform. However if the Temporal or Timing Specification or the instruction set required to support a Vector prohibits direct mapping or emulation of the Vector to the preferred hardware platform, the Scaled Virtual Machine of the Vector would be mapped or allocated to hardware and software elements supplementing the preferred platform.

Accordingly at the end of the mapping process, the design of each Vector can be mapped or allocated to specific hardware and/or software objects or elements. The specifications of the preferred platform together with the description of the supplementary hardware elements will typically describe the system hardware required to run the system software objects or elements.

Re-configurable Hardware Platforms are being sought by designers looking to bridge the gap between general-purpose processors and custom integrated circuits (logic) implementations. However, a design methodology that can effectively transfer the system design onto re-configurable hardware platforms does not yet exist, primarily because of the lack of a design methodology that can effectively de-couple the application from the implementation architectures.

The Unified Design Methodology 200 generally enables the de-coupling of the application from specific implementation architectures. Using the Methodology 200, the system designer can design the architecture for a particular application then superimpose that architecture on a target reconfigurable hardware platform. As such, the Unified Design Methodology 200 can be an effective tool for targeting re-configurable hardware platform.

The Unified Design Methodology 200 can be applied in several different ways depending upon the type and capabilities of the target re-configurable hardware platform. To better address that point, a general description of various domains of re-configurable hardware platforms will be provided below.

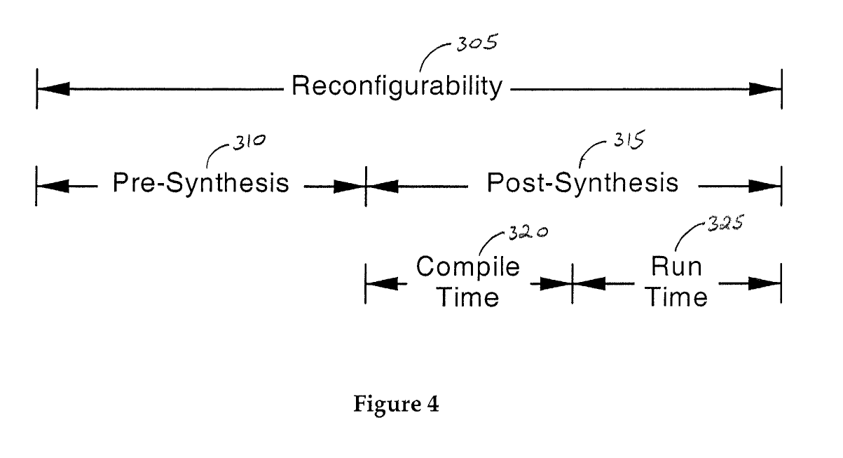

FIG. 4 generally illustrates various exemplary domains of reconfigurable hardware platforms 305, including platforms that are reconfigurable in the Pre-Synthesis domain 310, and platforms that are reconfigurable in the Post-Synthesis domain 315.

Regarding a re-configurable platform in the Pre-Synthesis domain 310, elements of the platform are generally pre-designed within an architectural context that allows the elements to be readily integrated into the platform architecture and/or modified to fulfill a set of specified processing requirements. After the platform is configured in the Pre-Synthesis domain 310, it is transformed through a physical realization process into actual hardware.

As shown in FIG. 2A, the Unified Design Methodology 200 generally provides a mechanism in Tier 3 215 to incorporate the attributes and capabilities of a platform in mapping the design information included in the Conjugate Virtual Machine field 115 (shown in FIG. 3A) onto the platform objects or elements. In doing so, the Unified Design Methodology 200 can be compatible with platforms that can be re-configured in the Pre-Synthesis domain 310 (shown in FIG. 4).

Returning to FIG. 34 platforms that are re-configurable in the Post-Synthesis domain 315 are generally designed to allow some attributes and capabilities of the hardware to be re-configurable in the Post-Synthesis domain 315. In other words, objects or elements of a Post-Synthesis Re-Configurable Platform offers certain degree of variability that can be utilized in some cases only at compile-time 320 and in other cases at run-time 325.

Accordingly, the capabilities of a re-configurable platform in Post-Synthesis domain 315 can be adjusted to match the processing needs of specific applications while benefiting from the production volume advantages realized when the platform is used in multiple applications. The flexibility of reconfigurable platforms in the Post-Synthesis domain can allow the platforms to be used in applications requiring compatibility with multiple (communications) standards.

Returning to FIG. 2A, the Unified Design Methodology 200 generally provides a mechanism in Tier 3 215 to use the Conjugate Virtual Machine field 115 of Vector design data records 100 (shown in FIG. 3A) to specify hardware attributes and capabilities required to support each Vector. In other words, the Conjugate Virtual Machine field 115 of each Vector can be used to specify the features and capabilities that a Post-Synthesis re-configurable platform needs to satisfy in order to support each Vector. Accordingly, the Unified Design Methodology 200 can be compatible with platforms that re-configurable in the Post-Synthesis domain 315 (shown in FIG. 4).

Returning to FIG. 4, re-configurable platforms in the Post-Synthesis domain 315 can be further divided into platforms that can be re-configured at compile-time 320 and platforms that can be re-configured at run-time 325. Several emerging Post-Synthesis re-configurable platforms are based on Field Programmable Gate Arrays (FPGA) and Programmable Logic Devices (PLD). These FPGA-based and PLD-based platforms can be re-configured at compile time.

The Conjugate Virtual Machine field 115 in each Vector 200 (shown in FIG. 3A) can be used by a platform-specific compiler to generate description of the logic, the placement, and the routing information in a format that can be used to directly re-configure the platform. The remaining design aspects contained in the Design Vectors 100 can be mapped into software that is compiled separately to run on the re-configured platform.

The attributes of a Run-time Re-configurable Platform are usually altered parametrically, i.e., through downloading of new values for a set of reprogrammable parameters. Tier 3 215 of the disclosed Unified Design Methodology 200 (shown in FIG. 2A) enables incorporation of the preferred platform capabilities and attributes including the flexible adjustments of features and capabilities of the platform by re-configuring certain hardware parameters. Tier 3 215 takes into account such flexible adjustments of features and capabilities by mapping the Conjugate Virtual Machine field 115 of each Vector 100 (shown in FIG. 3A) onto the preferred hardware platform and then generating appropriate values for the re-programmable parameters.

In short, the Conjugate Virtual Machine field 115 in each Vector 100 (shown in FIG. 3A) generally allows the Unified Design Methodology 200 (shown in FIG. 2A) to address a plurality of ways to realize the system hardware. In Pre-Synthesis domain 310, the Conjugate Virtual Machine field 115 can be mapped onto pre-designed elements of a target re-configurable platform. In the Post-Synthesis domain 315, the Conjugate Virtual Machine field 115 can be used to generate the configuration parameters of the target re-configurable platform.

It should be noted that the functional components illustrated in the above-referenced figures and discussed above could be implemented in hardware or software. If the aforementioned functional components are implemented in software, these components can be stored on a computer-readable medium, such as floppy disk, hard drive, CD-ROM, DVD, tape, memory, or any storage device that is accessible by a computer.

While certain exemplary embodiments have been described and shown in accompanying drawings, it is to be understood that such embodiments are merely illustrative of and not restrictive on the broad invention, and that the invention not be limited to the specific constructions and arrangements shown and described, since various other modifications may occur to those ordinarily skilled in the art.

What is claimed is:

1. A method to efficiently design and implement a matched instruction set processor system, including:
analyzing and mapping design specifications of the matched instruction set processor into application components, each application component representing a reusable function commonly used in digital communication systems;
decomposing the matched instruction set processor system into interconnected design vectors, the interconnected design vectors are represented in Java programming language; and
analyzing and mapping the interconnected design vectors into specific hardware and software elements.

2. The method of claim 1, wherein analyzing and mapping design specifications further includes:
performing a behavioral analysis of the matched instruction set processor system to ensure compliance with the design specifications.

3. The method of claim 1, wherein analyzing and mapping design specifications further includes:
performing a requirement analysis of the design specifications of the matched instruction set processor system to generate a behavioral model; and
representing the behavioral model using application components.

4. The method of claim 1, wherein decomposing the matched instruction set processor system into interconnected design vectors further includes:
mapping the application components into corresponding architectural components.

5. The method of claim 4, wherein decomposing the matched instruction set processor system into interconnected design vectors further includes:
decomposing each application component into processing pipelines to satisfy system processing and timing requirements.

6. The method of claim 5, wherein decomposing the matched instruction set processor system into interconnected design vectors further includes:
decomposing each processing pipeline into design vectors, including functional design vectors and interconnect design vectors.

7. The method of claim 6, wherein decomposing the matched instruction set processor system into interconnected design vectors further includes:
using the functional design vectors to represent design information for at lease one functional aspect of the processing pipeline; and
using the interconnect design vectors to contain connectivity characteristics of the processing pipeline.

8. The method of claim 7, wherein decomposing the matched instruction set processor system into interconnected design vectors further includes:
providing in each design vector a binding header method, a run method, a Java virtual machine (JVM), a binding trailer method, and an invocation method.

9. A system to efficiently design and implement a matched instruction set processor system, including:
an application modeling unit to analyze and map design specifications of the matched instruction set processor into application components, each application component representing a reusable function commonly used in digital communication systems;
an architectural modeling unit operatively coupled to the application modeling unit, the architectural modeling unit decomposing the matched instruction set processor system into interconnected design vectors, the design vectors are represented in Java programming language; and
a realization mapping unit operatively coupled to the architectural modeling unit, the realization mapping unit analyzing and mapping the interconnected design vectors into specific hardware and software elements.

10. The system of claim 9, wherein the application modeling unit performs a behavioral analysis of the matched instruction set processor system to ensure compliance with the design specifications.

11. The system of claim 9, wherein the application modeling unit performs a requirement analysis of the design specifications of the matched instruction set processor system to generate a behavioral model.

12. The system of claim 9, wherein the application modeling unit represents the behavioral model using application components.

13. The system of claim 9, wherein the architectural modeling unit maps the application components into corresponding architectural components.

14. The system of claim 13, wherein the architectural modeling unit decomposes each application component into processing pipelines to satisfy system processing and timing requirements.

15. The system of claim 14, wherein the architectural modeling unit decomposes each processing pipeline into design vectors, including functional design vectors and interconnect design vectors.

16. The system of claim 15, wherein the architectural modeling unit uses the functional design vectors to represent design information for at lease one functional aspect of the processing pipeline.
using the interconnect design vectors to contain connectivity characteristics of the processing pipeline.

17. The system of claim 15, wherein the architectural modeling unit uses the interconnect design vectors to contain connectivity characteristics of the processing pipeline.

18. The system of claim 17, wherein the architectural modeling unit provides in each design vector a binding header method, a run method, a Java virtual machine (JVM), a binding trailer method, and an invocation method.

19. A machine-readable medium comprising instructions which, when executed by a machine, cause the machine to perform operations comprising:
analyzing and mapping design specifications of the matched instruction set processor into application components, each application component representing a reusable function commonly used in digital communication systems;
decomposing the matched instruction set processor system into interconnected design vectors, the design vectors are represented in Java programming language; and
analyzing and mapping the interconnected design vectors into specific hardware and software elements.
